(19) United States
(12) Patent Application Publication
(10) Pub. No.: US 2016/0347239 A1
(43) Pub. Date: Dec. 1, 2016

(54) ATTACHABLE REMOTE CONTROLLED LIGHTING SYSTEM FOR VEHICLES

(71) Applicant: Mike Diaz, Jr., Houston, TX (US)

(72) Inventor: Mike Diaz, Jr., Houston, TX (US)

(21) Appl. No.: 14/722,218

(22) Filed: May 27, 2015

(51) Int. Cl. B60Q 1/26; H05B 37/02

(52) U.S. Cl. CPC B60Q 1/2615; H05B 37/0272

(57) ABSTRACT

An attachable supplemental lighting system for placement on a truck, trailer or large vehicle so as to provide a more prominent display of the operator's directional maneuvering intentions, such as intentions to turn or change lanes. The attachable supplemental lighting system includes a plurality of discrete lighting assemblies that are attachable to a vehicle and each include a plurality of lighting elements that provide a directional indication when in place on the vehicle. The lighting assemblies are bonded with a remote device which provides a user interface for selectively activating the lighting elements on the lighting assemblies in a first direction, a second direction, or both.

### BACKGROUND OF THE INVENTION

Field of the Invention

This invention relates generally to vehicle attachments and, more particularly, to removably attachable, wireless remote controlled lighting components for vehicles.

Description of the Prior Art

The use of large trucks for transport goods over long distances is well known. Because of the size and the amount of road space such large vehicles occupy, both their operators and the operators of nearby vehicles must generally exercise an abundance of caution when performing even the most basic driving maneuvers, such as changing lanes or turning. Despite such efforts, a problem which still exists is that drivers of nearby vehicles are often unable to ascertain the maneuvering intentions of the large truck because their turn signal indicator lights are often very small and located in a relatively low place on the vehicle. Thus, there remains a need for an attachable supplemental lighting system which provides a more prominent display of indicator lights on a large truck. It would be helpful if such an attachable supplemental lighting system included an antenna that enabled them to be controlled remotely. It would be additionally desirable for such an attachable supplemental lighting system to be removably attachable in a selected location to a truck or trailer through a magnet based fastener.

The Applicant's invention described herein provides for an attachable supplemental lighting system adapted to provide a more prominent indicator light display that was actuated through a wireless controller. The primary components in Applicant's attachable supplemental lighting system are a plurality of lighting assemblies and a wireless controller. When in operation, the attachable supplemental lighting system enables more effective signaling of the maneuvering intentions of a large truck to nearby drivers. As a result, many of the limitations imposed by prior art structures are removed.

### SUMMARY OF THE INVENTION

An attachable supplemental lighting system for placement on a truck, trailer or large vehicle so as to provide a more prominent display of the operator's directional maneuvering intentions, such as intentions to turn or change lanes. The attachable supplemental lighting system includes a plurality of discrete lighting assemblies that are attachable to a vehicle and each include a plurality of lighting elements that provide a directional indication when in place on the vehicle. The lighting assemblies are bonded with a remote device which provides a user interface for selectively activating the lighting elements on the lighting assemblies in a first direction, a second direction, or both.

It is an object of this invention to provide an attachable supplemental lighting system which provides a more prominent display of indicator lights on a large truck.

It is another object of this invention to provide an attachable supplemental lighting system that included an antenna that enabled them to be controlled remotely.

It is yet another object of this invention to provide an attachable supplemental lighting system which is removably attachable in a selected location to a truck or trailer through a magnet based fastener.

It is still another object of this invention to provide an adjustable extension bar which reduces the amount of time a use spent searching for the right length of a fixed extension bar.

These and other objects will be apparent to one of skill in the art.

### BRIEF DESCRIPTION OF THE DRAWINGS

FIG. 1 is an elevational view of an attachable supplemental lighting system built in accordance with the present invention mounted on the back of a trailer.

FIG. 2 is a front elevational view of a lighting assembly of an attachable supplemental lighting system built in accordance with the present invention.

FIG. 3 is a back elevational view of a lighting assembly of an attachable supplemental lighting system built in accordance with the present invention.

FIG. 4 is a side elevational view of a lighting assembly of an attachable supplemental lighting system built in accordance with the present invention.

FIG. 5 is a front elevational view of a remote device of an attachable supplemental lighting system built in accordance with the present invention.

### DETAILED DESCRIPTION OF THE INVENTION

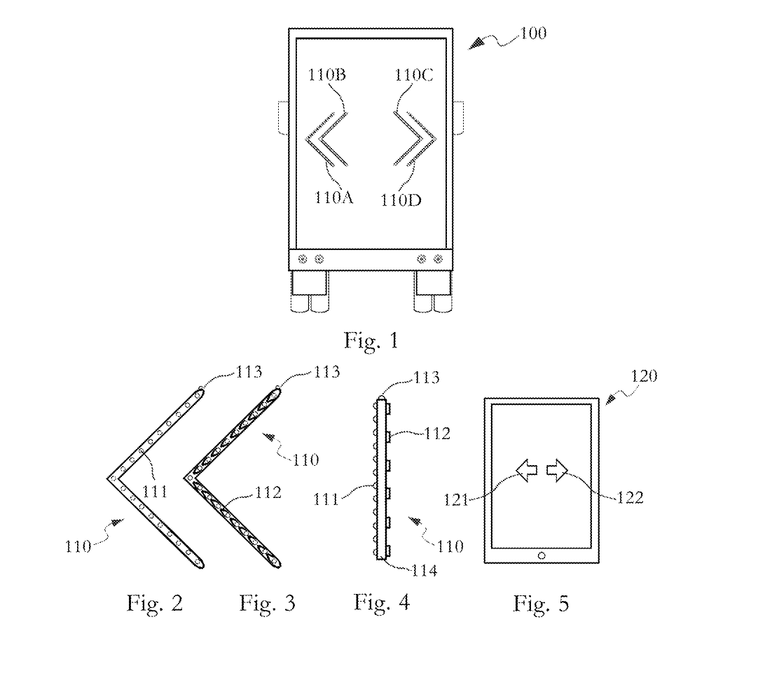

Referring now to the drawings and in particular FIGS. 1, 2, 3, 4, and 5, an attachable supplemental lighting system is suitable for attaching to the rear of a conventional truck or trailer 100. The attachable supplemental lighting system defines a plurality of discrete lighting assemblies 110A, 110B, 110C, 110D (collectively, 110), each of which define an elongated, angular member that includes a plurality of lighting elements 111 on a front side and a plurality of attachment members 112 on a back side. The lighting assemblies 110 additionally include a pairing actuator 113, a USB receptacle 114, an internal battery, an internal controller, and an internal antenna. In the preferred embodiment, the lighting elements 111 each define a an LED lighting element that is electrically connected to the controller and battery and the attachment members 112 each define a magnet.

The controller, antenna, battery, lighting elements 111, USB receptacle 114 and pairing actuator 113 are all electrically interconnected such that the controller can selectively supply electricity from the battery to the lighting elements 111 so as to activate or deactivate the lighting elements 111 upon the antenna's receipt of an electrical indication signal from a remote device 120. In one embodiment, the antenna defines a Bluetooth antenna which allows the controller to receive electrical signals from a remote device 120 wirelessly. It is contemplated that each lighting assembly 110 includes a unique identifier and can be separately bonded with a remote device 120, with the bond generated through a conventional pairing process initiated on the lighting assembly 110 by the pairing actuator 113.

Accordingly, once a user attaches a plurality of lighting assemblies 110 to a vehicle in a set arrangement, as illustrated by FIG. 1, the user can sequentially pair a conventional Bluetooth enabled remote device 120, such as a smart phone, with each lighting assembly 110. In one embodiment, the first lighting assembly 110A and the third lighting assembly 110B bonded will correspond on the remote device 120 to an electrical indication signal actuator in a first direction 121 and the second lighting assembly 110C and the fourth lighting assembly 110D bonded will correspond on the remote device 120 to an electrical indication signal actuator in a second direction 122. Thus, when four lighting assemblies 110 are attached to the vehicle 100 and bonded with the remote device 120, the lighting elements 110A, 110B pointing in a first direction correspond with the electrical indication signal actuator in a first direction 121 and the lighting elements 110C, 110D pointing in a second direction correspond with the electrical indication signal actuator in a second direction 122, and a user can selectively activate one set of the lighting elements 110A, 110B or the other set of lighting elements 110C, 110D by actuating the electrical indication signal actuator in a first direction 121 or electrical indication signal actuator in a second direction 122, respectively.

In one embodiment, the lighting assemblies 110 are constructed of or coated with a reflective material.

It is contemplated that when the lighting elements 111 on a particular lighting assembly 110 are activated, they may blink together or illuminate sequentially toward their center.

It is appreciated that the battery may be recharged through connecting a conventional USB plug that is connected to an electrical outlet (or other power source) to the USB receptacle 114.

In an alternate embodiment, the lighting assemblies are wireless bonded together and one of said lighting elements is electrically connected to the host vehicle's existing turn signal wiring so as to allow the lighting assemblies to be activated and deactivated in concert with the host vehicle's existing turn signals.

The instant invention has been shown and described herein in what is considered to be the most practical and preferred embodiment. It is recognized, however, that departures may be made therefrom within the scope of the invention and that obvious modifications will occur to a person skilled in the art.

1. An attachable supplemental lighting system for placement on a vehicle, comprising:
at least one lighting assembly having a front side and an opposing back side, wherein said at least one lighting assembly is configured to attach to a vehicle exterior;
at least one lighting element disposed on said front side, wherein said at least one lighting element is oriented so as to define a directional indication;
said at least one lighting element operatively connected to a controller and a power source housed in the lighting assembly such that the controller enables selective provision of electricity to the at least one lighting elements;
said controller operatively connected to a Bluetooth antenna integral with said at least one lighting assembly so as to enable the controller to selectively provide electricity to the at least one lighting elements in response to wireless electrical signals received by the Bluetooth antenna; and
a pairing actuator integral with said at least one lighting assembly and connected to said Bluetooth antenna, wherein said pair actuator adapts the at least one lighting assembly to be selectively bonded with a Bluetooth enabled remote device so as to allow the remote device to transmit wireless electrical signals to the Bluetooth antenna.

2. The attachable supplemental lighting system of claim 1, additionally comprising at least one attachment member on the back side, wherein said at least one attachment member configures the lighting assembly to attach to the vehicle exterior.

3. The attachable supplemental lighting system of claim 2, wherein said at least one attachment member defines a magnet.

4.-5. (canceled)

6. An attachable supplemental lighting system for placement on a vehicle, comprising:
at least one lighting assembly having a front side and an opposing back side, wherein said at least one lighting assembly is configured to attach to a vehicle exterior;
at least one lighting element disposed on said front side, wherein said at least one lighting element is oriented so as to define a directional indication;
at least one attachment member on the back side, wherein said at least one attachment member configures the lighting assembly to attach to the vehicle exterior;
said at least one lighting element operatively connected to a controller and a power source housed in the lighting assembly such that the controller enables selective provision of electricity to the at least one lighting elements;
a plug receptacle integral with said at least one lighting assembly, wherein said plug receptacle is adapted to connect to an external power source so as to allow electricity to be directed to the power source housed in the lighting assembly; and
said controller operatively connected to an antenna so as to enable the controller to selectively provide electricity to the at least one lighting elements in response to wireless electrical signals received by the antenna.

7. The attachable supplemental lighting system of claim 6, wherein said at least one attachment member defines a magnet.

8. The attachable supplemental lighting system of claim 6, wherein said antenna defines a Bluetooth antenna.

9. The attachable supplemental lighting system of claim 8, additionally comprising a pairing actuator integral with said at least one lighting assembly and connected to said Bluetooth antenna, wherein said pair actuator adapts the at least one lighting assembly to be selectively bonded with a Bluetooth enabled remote device so as to allow the remote device to transmit wireless electrical signals to the Bluetooth antenna.

10. The attachable supplemental lighting system of claim 6, wherein said plug receptacle defines a Universal Serial Bus receptacle.

11. The attachable supplemental lighting system of claim 1, additionally comprising a plug receptacle integral with said at least one lighting assembly, wherein said plug receptacle is adapted to connect to an external power source so as to allow electricity to be directed to the power source housed in the lighting assembly.

12. The attachable supplemental lighting system of claim 11, wherein said plug receptacle defines a Universal Serial Bus receptacle.
